(19) United States
(12) Patent Application Publication
(10) Pub. No.: US 2007/0269681 A1
(43) Pub. Date: Nov. 22, 2007

(54) HIGH-FREQUENCY MAGNETIC MATERIAL

(76) Inventors: Fumihiko AIGA, Yokohama-shi (JP); Seiichi Suenaga, Yokohama-shi (JP); Maki Yonetsu, Mitaka-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/746,240

(22) Filed: May 9, 2007

(30) Foreign Application Priority Data
May 18, 2006 (JP) 2006-139286

(51) Int. Cl. B32B 5/16; B32B 15/00

(52) U.S. Cl. 428/692.1; 428/402

(57) ABSTRACT

A high-frequency magnetic material comprises an artificial medium having a structure in which a plurality of unit particles align in a matrix medium, wherein the unit particle is composed of a split ring type conductor, or a combination of the split ring type conductor and a dielectric material, and the matrix medium contains a magnetic material.

### CROSS-REFERENCE TO RELATED APPLICATIONS

This application is based upon and claims the benefit of priority from prior Japanese Patent Application No. 2006-139286, filed May 18, 2006, the entire contents of which are incorporated herein by reference.

### BACKGROUND OF THE INVENTION

1. Field of the Invention

The present invention relates to a novel high-frequency magnetic material prepared from an artificial medium.

2. Description of the Related Art

Heretofore, ferrite and the like have been used for a high-frequency magnetic material. However, when such a high-frequency magnetic material is used in a gigahertz band of frequency, a so-called “limit of Snooke” becomes a problem, whereby a higher magnetic permeability cannot be obtained.

On the other hand, JP-A 2002-374107 (KOKAI) and IEEE Transactions on Microwave Theory and Techniques, Vol. 47, 2075 (1999) disclose that an artificial medium having physical properties different from those belonging essentially to a certain material itself can be realized by contriving a unit particle consisting of a metal or the like having a size corresponding to around a wavelength of the electromagnetic wave to be used or less is used, and arranging such unit particles. In addition, these documents disclose that an artificial medium can be applied to a left-handed system medium, a resonator, and an artificial dielectric material.

### BRIEF SUMMARY OF THE INVENTION

According to the present invention, there is provided a high-frequency magnetic material comprising an artificial medium having a structure in which a plurality of unit particles align in a matrix medium,

wherein the unit particle is composed of a split ring type conductor, or a combination of the split ring type conductor and a dielectric material, and

the matrix medium contains a magnetic material.

### BRIEF DESCRIPTION OF THE SEVERAL VIEWS OF THE DRAWING

FIG. 1 is an overview showing a basic constitution of a high-frequency magnetic material (resonator) according to an embodiment;

FIG. 2 is a view showing another conformation of a unit particle used for the high-frequency magnetic material (resonator) according to the embodiment;

FIG. 3 is a view showing still another conformation of the high-frequency magnetic material (resonator) according to the embodiment;

FIG. 4 is view showing yet another conformation of the high-frequency magnetic material (resonator) according to the embodiment;

FIG. 5 is a block diagram showing evaluation equipment for magnetic permeability of the high-frequency magnetic material (resonator) according to the embodiment;

FIG. 6 is a diagram showing frequency dependency of yy component of a real part in magnetic permeability tensor of the high-frequency magnetic material (resonator) according to the embodiment; and

FIG. 7 is an overview showing the high-frequency magnetic material (resonator) manufactured in example 1.

### DETAILED DESCRIPTION OF THE INVENTION

In the following, a high-frequency magnetic material according to an embodiment of the present invention will be described with reference to the accompanying drawings.

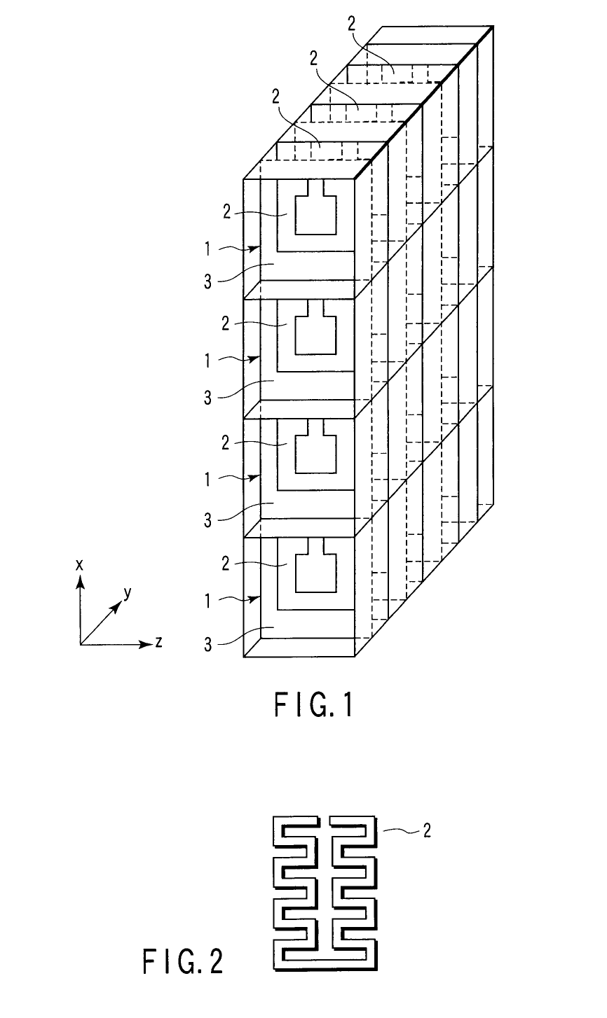

FIG. 1 is an overview showing a basic constitution of a resonator being one application of the high-frequency magnetic material according to the embodiment. The resonator has a constitution in which split ring resonators 1 are periodically disposed two-dimensionally with substantially equal intervals, respectively. The split ring resonator 1 has a structure in which a sprit ring 2 as a unit particle aligns in a matrix medium 3. In an embodiment, the sprit ring 2 is attached to a matrix medium 3 by means of inlay to align the matrix medium 3. The unit particle is made of a metal having a low conductor loss, for example, copper.

The split ring 2 is not limited to a metal, but a superconductive material may also be used.

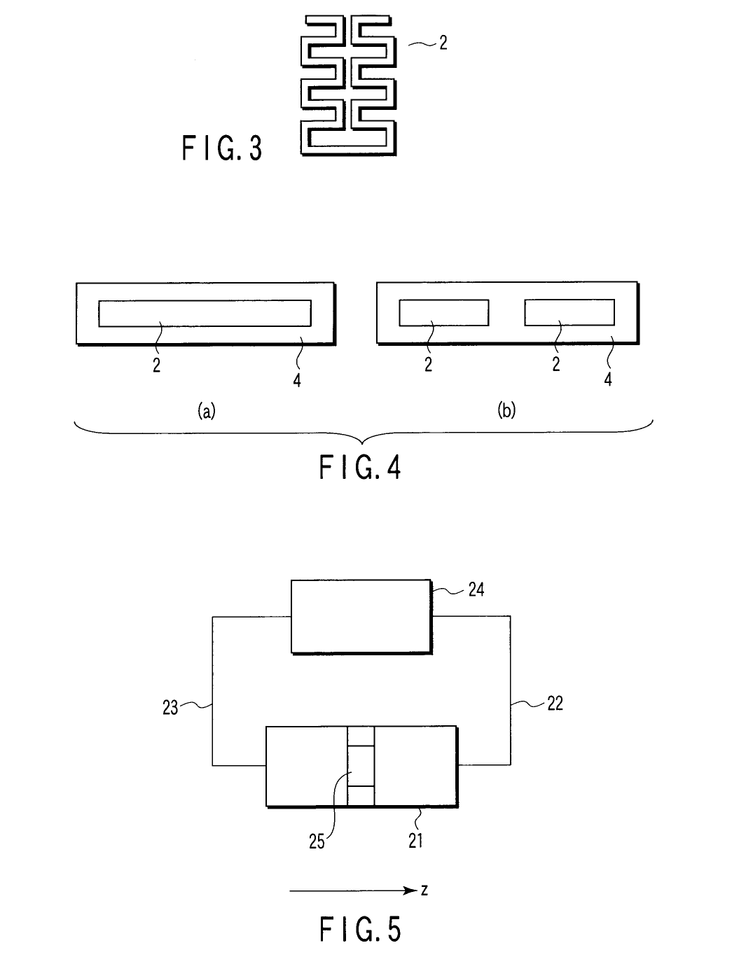

The split ring 2 is not limited to the shape shown in FIG. 1, but it may be a conductor piece having a ring-shaped figure in the x-z plane, for example, a split ring 2 of a meander open loop shape as shown in FIGS. 2 and 3.

The matrix medium contains a magnetic material. The matrix medium containing a magnetic material has anisotropy in the magnetic permeability, and it is preferred to have such a constitution that a direction of the maximum magnetic permeability coincides with a direction of normal vector in the plane formed by a split ring.

A specific example of the matrix medium includes at least one magnetic metal selected from the group consisting of Fe, Ni, and Co; or a composite material of a magnetic alloy and at least one insulating material selected from the group consisting of oxide, nitride, carbide, and fluoride of at least one metal element selected from the group consisting of Mg, Al, Si, Ca, Cr, Ti, Zr, Ba, Sr, Zn, Mn, Hf, and rare-earth elements. The matrix medium is preferably prepared from a composite material obtained by dispersing a magnetic material into an insulating material.

Particularly, it is more preferable that the composite material takes a configuration of composite particles consisting of magnetic particles and the insulating material. In such a configuration of the composite particles, it is preferred to integrally mold the composite particles with a synthetic resin such as polystyrene, polyethylene, polyethylene terephthalate (PET), and epoxy resins; or glass in the case where magnetic particles are deposited on the surface of a composite material. The integrally molded matrix medium is preferred that the insulation resistance thereof is 1×10² μΩ·cm or higher; or more preferably 1×10⁹ μΩ·cm or higher at room temperature.

Magnetic particles and insulating materials constituting the composite material as described above will be fully described hereinafter.

(Magnetic Particle)

1) Composition of Magnetic Particle

Examples of the magnetic particles include at least one member selected from the group consisting of Fe particle, Co particle, Fe—Co alloy particle, Fe—Co—Ni alloy particle, Fe group alloy particle, and Co group alloy particle. Among these magnetic particles, Fe-based alloy particle contained partially Co or Ni is preferably used, because the Fe-based alloy particle has an excellent oxidation resistance. Particularly, Fe—Co-based particle having a high saturation magnetization is preferable.

The magnetic particle may be an alloy prepared from at least one magnetic metal selected from Fe, Ni and Co, and a non-magnetic metal element. In this alloy, when an amount of the non-magnetic metal element is too large, the saturation magnetization becomes too low, so that it is preferred to prepare the alloy with the non-magnetic metal element in an amount of 10 atomic percent or less. Examples of the magnetic alloy particles include Fe—Co—B magnetic alloy particle in an amorphous state.

Furthermore, the non-magnetic metal may be dispersed alone into the composite material. In this case, it is preferred that an amount of the non-magnetic metal is 20% or less in volume ratio.

2) Particle Diameter of Magnetic Particle

The magnetic particle has preferably a particle diameter of 1 to 1000 nm, and more preferably 1 to 100 nm. If a particle diameter exceeds the upper limit of a particularly preferred particle diameter (100 nm) of the magnetic particle, there is a risk of occurrence of eddy-current loss in the case when the magnetic particle is used for electronic telecommunication equipment or the like. In addition, if a particle diameter of the magnetic particle exceeds 100 nm, the magnetic particle takes multiple domain magnetic structure which is more stable than single domain magnetic structure in energetical point of view. The high frequency property of magnetic permeability in the multiple domain magnetic structure becomes lower than that of magnetic permeability in the single domain magnetic structure. Accordingly, it is important that magnetic metal particles (or magnetic alloy particles) are allowed to exist as single domain magnetic particles in a composite material to be used for the matrix medium in the embodiment. Since the particle diameter limit of magnetic particles for maintaining stably the single domain magnetic structure is around 50 nm, it is more preferred that the particle diameter is allowed to be 50 nm or less. On the other hand, if a particle diameter of magnetic particles is made to be less than 1 nm, there is such a risk that the magnetic particles exhibit super paramagnetism so that saturation magnetic flux density decreases. In view of such magnetic particles and the relationship of the behavior derived therefrom, it is preferred that a particle diameter of the magnetic particles is made to be 1 to 100 nm, and particularly 10 to 50 nm.

(Insulating Material)

An insulating material is at least one material selected from the group consisting of oxide, nitride, carbonate, and fluoride of at least one metal element selected from the group consisting of Mg, Al, Si, Ca, Cr, Ti, Zr, Ba, Sr, Zn, Mn, Hf, and rare earth elements as mentioned above. Among these materials, oxides of metal elements are preferred, and particularly oxides of Mg, Al, and Si are preferable.

(Dispersed Condition of Magnetic Particles)

A dispersed condition of the magnetic particles in the matrix medium into the insulating material is important in a combination with a split ring, from viewpoint of improvements in the property (particularly, magnetic permeability and resonant frequency) of a high-frequency magnetic material.

In the composite material composed of magnetic particles and insulating material, it is preferred magnetic particles are present in the insulating material with a space of 1 to 100 nm, and more preferably 5 to 20 nm. As the space between magnetic particles exceeds 100 nm, particularly 20 nm, magnetic combination strength among the magnetic particles is larger and therefore magnetic permeability is larger. On the other hand, when the space is less than 1 nm, particularly 5 nm, electrical resistance becomes small. Small electrical resistance is unfavorable since eddy current loss is large when the used frequency is high. Therefore, it is preferred that magnetic particles are present in the insulating material with a space of 1 to 100 nm, and more preferably 5 to 20 nm in order to realize high magnetic permeability with high electrical resistance. According to such magnetic particles as mentioned above, a composite material, i.e., a matrix medium, having a high electrical resistance of 1 Ω·cm or more can be realized. As a result, it becomes possible to take a high resonant frequency with much smaller eddy current loss in a high-frequency magnetic material.

The resonant frequency can be controlled mainly by saturation magnetization and magnetic anisotropy. Saturation magnetization can be controlled by the kind of magnetic particle and the dispersed conditions of the magnetic particles (volume fraction of the magnetic particles in the matrix medium). Magnetic anisotropy can be controlled by particle shape, crystalline phase, particle diameter, an intergranular distance and the kind of magnetic particle. By controlling saturation magnetization and magnetic anisotropy, it becomes possible to take the resonant frequency thereof in a high level (1 to 20 GHz).

For example, evidence of the above description is that each of the magnetic particles has shape anisotropy such as a columnar structure. Each of the columnar magnetic particles is preferably insulated with a layer of an insulating material. The insulation is effectively made by electrical insulation. In the magnetic particles having a columnar structure, it is preferred that an axis of easy magnetization of a magnetic metal crystal constituting the columnar crystal is orientated along the longitudinal direction thereof.

In the magnetic particles having a columnar structure, shape anisotropy is very large and the dispersion of the magnetic anisotropy is quite small. Therefore, the resulting composite material (matrix medium) can take a high resonant frequency and can decrease a loss component represented by the imaginary part of magnetic permeability.

In the magnetic particles having a columnar structure, when the magnetic particles are magnetically combined with each other, it is preferred that the columnar magnetic particles are dispersed such that the longitudinal direction thereof is in a direction perpendicular to the combination direction thereof in the composite material, and that the composite material has the magnetic anisotropy (uniaxial anisotropy) in one direction in the plane. The composite material (matrix medium) having such constitution as described above can increase the real part of magnetic permeability.

A magnitude of the uniaxial anisotropy of a composite material is preferably 100 Oe or more, and more preferably 200 Oe or more, when it is indicated by a value of Ha (anisotropic magnetic field).

Particularly, when a matrix medium constituted from a composite material having anisotropy in the plane thereof is used, it is preferred that a direction of the anisotropy is arranged to be perpendicular to the magnetic field.

It should be noted that an arrangement of the split ring resonator 1 is not limited to the periodical arrangement shown in FIG. 1, but it may be properly modified as to a distance between split rings, and the number of the split rings in x- and y-directions. In general, it is preferred that a large number of split ring resonators are periodically disposed, but it is possible to operate the split ring resonators, even when at least two split ring resonators are disposed in one direction.

Moreover, it is preferred that a dielectric layer 4 is formed on the side (the surface) coming into contact with a matrix medium of the split ring 2 being the unit particle as shown in FIG. 4 [wherein (a) is a block diagram viewed from −x direction in FIG. 1, while (b) is a block diagram viewed from +x direction in FIG. 1], whereby the split ring 2 is electrically insulated from the magnetic material contained in the matrix medium. It is preferred to use a dielectric material having a small dielectric loss.

Furthermore, a combined structure of the split ring with the matrix medium is preferably arranged such that a space surrounding the split ring is covered with the matrix medium, but the matrix medium may exist only inside the space surrounded by the split ring. Specifically, a structure in which a split ring is fitted into a plate-like or a rod-shaped matrix medium from the outer circumferential part thereof is also applicable.

One example of evaluation equipment for magnetic permeability of the above-mentioned high-frequency magnetic material of FIG. 1 is shown in FIG. 5. Both ends of a square-shaped waveguide 21 are connected to a network analyzer 24 through RF cables 22 and 23, respectively. Inside the square-shaped waveguide 21, a high-frequency magnetic material (resonator) 25 is disposed. In this case, z-axis of the split ring resonator 1 of the high-frequency magnetic material (resonator) shown in FIG. 1 is allowed to coincide with the longitudinal direction (z-axial direction) of the square-shaped waveguide 21 as shown in FIG. 5. Microwaves are input to the square-shaped waveguide 21 from an output end of the network analyzer 24 through the RF cable 22 being one of the RF cables, while the microwaves are transmitted to the network analyzer 24 through the other RF cable 23 wherein a frequency response of S parameter is determined. Magnetic permeability is calculated from the S parameter obtained. In this case, the formula (9) described in the “IEEE Transactions on Microwave Theory and Techniques” Vol. 62, 33 (1974) is applied for the above calculation.

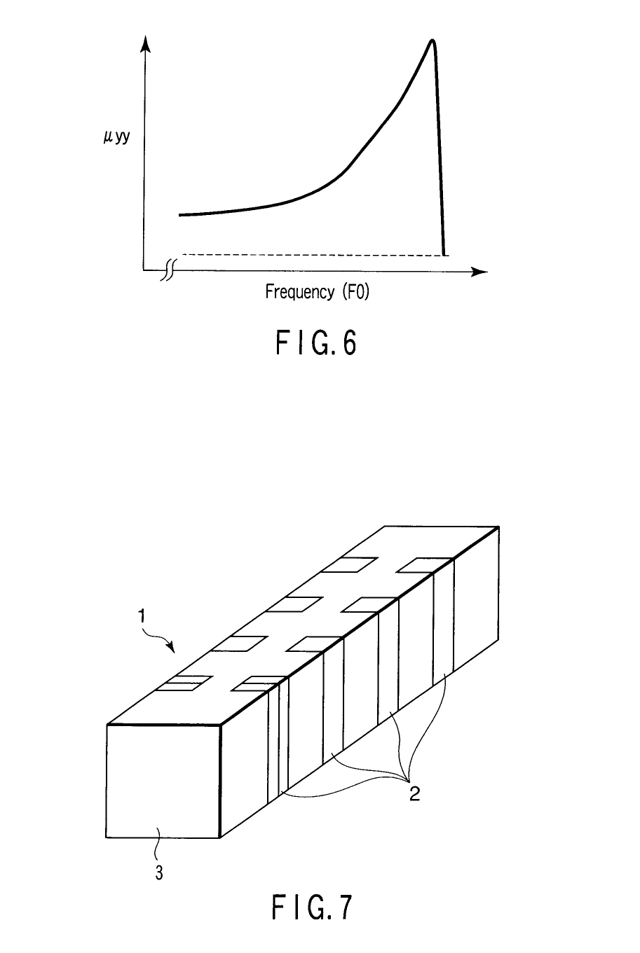

A frequency response of the S parameter of a high-frequency magnetic material is measured by such evaluation equipment as shown in FIG. 5, and the magnetic permeability determined in calculation by the use of the formula (9) is shown in FIG. 6. In FIG. 6, the solid line indicates typical frequency dependency of the real part yy component along normal vector direction in the plane made by a split ring of magnetic permeability tensor, while the dotted line indicates characteristics of only a matrix medium.

As is apparent from FIG. 6, it has been found that μyy increases remarkably in the vicinity of frequency F0 in the high-frequency magnetic material having the structure shown in FIG. 1, as compared with a case of only a matrix medium represented by the dotted line. In other words, it has been found that, when the high-frequency magnetic material is used in the vicinity of the frequency F0, it functions as a high magnetic permeability material.

The resonance frequency F0 may be adjusted by a shape and a manner for arrangement of a split ring, and a dielectric constant and magnetic permeability of a matrix medium, whereby a desired operating frequency can be obtained.

Other than the application of the equipment shown in FIG. 5, evaluation of magnetic permeability in a high-frequency magnetic material may be conducted by the manner described, for example, in “IEEE Transactions on Magnetics”, Vol. 38, 3174 (2002). Moreover, the evaluation of magnetic permeability of a high-frequency magnetic material can be estimated in accordance with an electromagnetic field simulation, when a dielectric constant, a magnetic permeability, a surface resistance and the like of the material have been known.

In the following, examples of the present invention will be fully described.

### EXAMPLE 1

Aqueous 25% tetramethyl ammonium hydroxide (TMAH) solution was prepared as an aqueous alkali solution. On the other hand, an aqueous solution which had been prepared by adjusting Co(NO₃)₂.6H₂O and Mg(NO₃)₂.6H₂O so as to obtain Co:Mg=4:1 (molar ratio) was prepared as an aqueous acid solution.

The aqueous acid solution was dropped to the aqueous alkali solution at a rate of 3 mL/minute. It was confirmed that pH of the solution was sufficiently basic at the time of the dropping. After completing the dropping, the solution was agitated for one hour, and left at rest for one hour thereby to completely precipitate the component. Then, a powder was collected by means of vacuum filtration, and the powder was dried at 110° C. for twelve hours in the atmosphere to obtain a precursor powder of (CO_{4/5}, Mg_{1/5})(OH)₂.

The aforesaid precursor powder was evaluated in accordance with the X-ray diffraction method. As a result, a broad peak of a solid solution of magnesium oxide and cobalt oxide was observed, whereby it was found that a low crystalline solid solution impalpable powder was synthesized.

The resulting solid solution impalpable powder was heated up to 800° C. under hydrogen atmosphere, thereby conducting reduction to synthesize a composite powder of a cobalt impalpable powder and magnesium oxide, and the resulting product was recovered in a glove box of argon atmosphere. As a result of a texture observation of the composite particles by means of a transmission electron microscope, an average particle diameter of the cobalt microparticles was about 20 nm.

The recovered composite powder of cobalt and magnesium oxide was kneaded together with polyvinylbutyral which is an organic-based binder to prepare slurry. Subsequently, the slurry was molded into a sheet-like material and pressed, whereby a sheet-like matrix medium was fabricated. It was confirmed that cobalt particles having an average diameter of 20 nm were contained in magnesium oxide at a volume fraction of 30% in the sheet-like matrix medium. Furthermore, high-frequency property was evaluated with respect to the aforesaid sheet-like matrix medium. As a result, it was found that the resonant frequency was about 9 GHz, the real part (μ′) of the magnetic permeability up to 5 GHz was 1.5, and the imaginary part (μ″) thereof was 0.1 or less.

Subsequently, the surface of a paper strip-like sheet piece cut out from the aforesaid sheet-like matrix medium was smoothed, and trenches each having a split spring shape were worked periodically and formed on the surface of the sheet piece. Thereafter, a Cu ring was fitted into each trench of the sheet-like matrix medium, whereby the sprit ring resonator 1 having the structure shown in FIG. 7 was fabricated. In FIG. 7, reference number 2 designates split rings, and 3 designates a matrix medium. Then, four structures obtained by covering the outer circumference of the split ring resonator 1 shown in FIG. 7 with an epoxy-based resin were prepared, and they were aligned to manufacture the same artificial medium (resonator) as that mentioned relating to FIG. 1.

The resulting artificial medium exhibited a resonant frequency of 4 GHz, and the magnetic permeability in the vicinity of 3.5 GHz was about 8.

### EXAMPLE 2

A sheet-like matrix medium was fabricated by molding the same slurry as that of example 1 into a sheet-like material in a magnetic field of 10 kOe, and pressing the sheet-like material. It was confirmed that cobalt particles having an average particle diameter of 20 nm were contained in magnesium oxide at a volume fraction of 30% in the sheet-like matrix medium. Furthermore, high-frequency property was evaluated with respect to the aforesaid sheet-like matrix medium. As a result, it was found that the matrix medium had anisotropy in uniaxial direction and a resonant frequency of about 10 GHz in the easy axial direction, and that the real part (μ′) of the magnetic permeability up to 5.5 GHz was 1.3, and the imaginary part (μ″) thereof was 0.1 or less.

Subsequently, the surface of a paper strip-like sheet piece cut out from the aforesaid sheet-like matrix medium such that the direction of the axis of easy magnetization was directed to the longitudinal direction thereof was smoothed, and grooves each having a split spring shape were worked periodically and formed on the surface of the sheet piece. Thereafter, a Cu ring was fitted into each groove of the sheet-like matrix medium, whereby the same artificial medium (resonator) as that shown in the above-mentioned FIG. 1 was manufactured.

The resulting artificial medium exhibited a resonant frequency of 4.2 GHz, and the magnetic permeability in the vicinity of 3.8 GHz was about 8.

### EXAMPLE 3

In accordance with the coprecipitation method, a mixed powder of magnesium oxide, iron oxide, and cobalt oxide was synthesized, and then dried. The resulting mixed powder (precursor powder) was evaluated in accordance with the X-ray diffraction method. As a result, a broad peak of the solid solution of magnesium oxide, iron oxide, and cobalt oxide was observed, and the synthesis of a low crystalline solid solution impalpable powder was confirmed.

The resulting solid solution impalpable powder was heated up to 800° C. under hydrogen atmosphere, thereby conducting reduction to synthesize a composite powder of an iron-cobalt impalpable powder and magnesium oxide, and the resulting product was recovered in a glove box of argon atmosphere. As a result of a texture observation of the composite particles by means of a transmission electron microscope, an average particle diameter of the iron-cobalt microparticles was about 30 nm.

The recovered composite powder of iron-cobalt and magnesium oxide was kneaded together with polyvinylbutyral being an organic-based binder to prepare slurry. The slurry was then molded into a sheet-like material and pressed, whereby a sheet-like matrix medium was fabricated. It was confirmed that iron-cobalt particles having an average diameter of 30 nm were contained in magnesium oxide at a volume fraction of 30% in the sheet-like matrix medium. Furthermore, high-frequency property was evaluated with respect to the aforesaid sheet-like matrix medium. As a result, it was found that the resonant frequency was about 8 GHz, the real part (μ′) of the magnetic permeability up to 4 GHz was 2.0, and the imaginary part (μ″) thereof was 0.1 or less.

Subsequently, the surface of a paper strip-like sheet piece cut out from the aforesaid sheet-like matrix medium was smoothed, and grooves each having a split spring shape were worked periodically and formed on the surface of the sheet piece. Thereafter, a Cu ring was fitted into each groove of the sheet-like matrix medium, whereby the same artificial medium (resonator) as that shown in the above-mentioned FIG. 1 was manufactured.

The resulting artificial medium exhibited a resonant frequency of 3.5 GHz, and the magnetic permeability in the vicinity of 3 GHz was about 10.

### EXAMPLE 4

Core shell type particles, each of which was prepared by coating a surface of a Co particle of 20 nm average particle diameter with a SiO₂ layer of 2 nm average thickness, were heated and compacted as a precursor into a sheet-like material while affording anisotropy in a 10 kOe magnetic field to obtain a sheet-like matrix medium. It was found that the cobalt particles were contained in the SiO₂ at a volume fraction of 50% in the sheet-like matrix medium. Furthermore, high-frequency property was evaluated with respect to the above-described sheet-like matrix medium. As a result, it was found that the resonant frequency was about 2.5 GHz, the real part (μ′) of the magnetic permeability was 50, and the imaginary part (μ″) thereof was 5 or less.

Subsequently, the surface of a paper strip-like sheet piece cut out from the aforesaid sheet-like matrix medium was smoothed, and grooves each having a split spring shape were worked periodically and formed on the surface of the sheet piece. Thereafter, a Cu ring was fitted into each groove of the sheet-like matrix medium, whereby the same artificial medium (resonator) as that shown in the above-mentioned FIG. 1 was manufactured.

The resulting artificial medium exhibited a resonant frequency of 1.5 GHz, and the magnetic permeability in the vicinity of 1.2 GHz was about 200.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A high-frequency magnetic material comprising an artificial medium having a structure in which a plurality of unit particles align in a matrix medium,
Wherein the unit particle is composed of a split ring type conductor, or a combination of the split ring type conductor and a dielectric material, and
the matrix medium contains a magnetic material.

2. The material according to claim 1, wherein the matrix medium has anisotropy in the magnetic permeability, and a direction of the maximum magnetic permeability coincides with a normal vector direction in a plane made by a split ring.

3. The material according to claim 1, wherein the matrix medium consists of a composite material containing magnetic particles and an insulating material.

4. The material according to claim 3, wherein the magnetic particles are prepared from at least one magnetic metal selected from the group consisting of Fe, Ni, and Co and a magnetic alloy containing the magnetic metal.

5. The material according to claim 3, wherein the insulating material is at least one material selected from the group consisting of oxide, nitride, carbonate, and fluoride of at least one metal element selected from the group consisting of Mg, Al, Si, Ca, Cr, Ti, Zr, Ba, Sr, Zn, Mn, Hf and rare earth elements.

6. The material according to claim 3, wherein the insulating material is an oxide of at least one metal element selected from the group consisting of Mg, Al, and Si.

7. The material according to claim 3, wherein each of the magnetic particles has a particle diameter of 1 to 100 nm.

8. The material according to claim 3, wherein each of the magnetic particles has a particle diameter of 10 to 50 nm.

9. The material according to claim 3, wherein the composite material is prepared by dispersing the magnetic particles into the insulating material with a space of 1 nm or more and 100 nm or less, and has an electric resistance of 1 Ω·cm or more.

10. The material according to claim 3, wherein each of the magnetic particles has shape anisotropy.

11. The material according to claim 3, wherein each of the magnetic particles has a columnar structure, and an axis of easy magnetization of a magnetic metal crystal constituting a columnar crystal is oriented in a longitudinal direction of the columnar crystal.

12. The material according to claim 3, wherein each of the magnetic particles has a columnar structure, and the magnetic particles are dispersed into the insulating material with a space of 1 nm or more and 100 nm or less.

13. The material according to claim 3, wherein the composite material has a structure in which the magnetic particles having a columnar structure are dispersed into the insulating material with a space of 1 nm or more and 100 nm or less, the columnar magnetic particles are dispersed such that the longitudinal direction thereof is perpendicular to the magnetically combined direction, and magnetic anisotropy extends unidirectionally in a plane.

14. The material according to claim 1, wherein the unit particle is composed of a combination of a split ring type conductor and a dielectric material, and the dielectric material being formed on the side coming into contact with the matrix medium.
